(19) United States
(12) Patent Application Publication
(10) Pub. No.: US 2007/0118606 A1
(43) Pub. Date: May 24, 2007

(54) Virtual content directory service

(75) Inventors: Bruce Duncan, Reading (GB); Dale R. Heron, Crawley (GB)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/577,897

(22) PCT Filed: Oct. 26, 2004
(86) PCT No.: PCT/IB04/52202

§ 371 Date: May 1, 2006

(30) Foreign Application Priority Data
Nov. 4, 2003 (GB) 0325673.2

(51) Int. Cl. G06F 15/16

(52) U.S. Cl. 709/217

(57) ABSTRACT

A serving device (MS) stores media content information (meta-data) in a directory, such as the Content Directory Service (CDS, 55) of UPnP. Querying devices, such as UPnP Control Point devices (CP), can query the CDS (55) to obtain information. An alternative representation of the CDS (V-CDS) is maintained by an entity of the system. The alternative, or ‘virtual’, CDS (V-CDS) stores selected information in a manner which can be more efficiently queried by querying devices. Preferably, the structure of the reorganised information is optimised for the specific browsing, searching and retrieval tasks of the user interface (UI) of a particular querying device. The virtual CDS (VCDS) can aggregate information from a number of different serving devices (MS-a, MS-b, FIG. 5) and can provide a service either to a single querying device or to a group of querying devices.

This invention relates to systems which use a content directory service, such as systems which conform to the Universal Plug and Play (UPnP) architecture.

There is an ever increasing use of digital storage devices to store media content. The media content can range from simple text files to multi-media content such as audio, pre-recorded or user-recorded video, broadcast digital audio (e.g. Internet radio), broadcast digital video or digital images (e.g. digital photos.)

Universal Plug and Play (UPnP) is a communications protocol which allows electronic devices produced by different manufacturers to operate with one another. UPnP is designed to support zero-configuration, “invisible” networking, with automatic discovery of new devices. This means a device can dynamically join a network, obtain an IP address, convey its capabilities, and learn about the presence and capabilities of other devices. A further development of UPnP is the UPnP Audio-Visual (AV) Architecture which describes extensions of the UPnP architecture relevant to Audio-Visual devices. The UPnP AV Architecture defines a Media Server, a Media Renderer and a Control Point.

Many devices within a UPnP compliant network, such as a UPnP home network, contain various types of content that other devices in the network would like to access (e.g. music, videos, still images, etc). As an example, a Media Server device might contain audio, video, and still-image libraries. In order for the user to enjoy this content, the user must be able to browse the objects stored on the Media Server, select a specific one, and cause it to be played on an appropriate rendering device (e.g. an audio player for music objects, a TV for video content, an Electronic Picture Frame for still-images, etc). For maximum convenience, it is desirable to allow the user to initiate these operations from a variety of user interface (UI) devices. In most cases, these UI devices will either be a UI built into the rendering device, or it will be a stand-alone UI device such as a wireless personal digital assistant (PDA) or tablet. It is desirable that a user can access the content without having to interact directly with the device containing the content.

One of the primary parts of the UPnP AV Architecture is the Content Directory Service (CDS). The CDS provides a set of features which allow UPnP Control Point (CP) devices to access the content stored on Media Server (MS) devices. The current publicly available description of CDS is the “Content Directory Service Template Version 1.01” for Universal Plug and Play Version 1.0, Jun. 25, 2002. The Content Directory Service allows clients (e.g. UI devices) to locate individual objects (e.g. songs, movies, pictures) that the server device is capable of providing. For example, this service can be used to provide a list of songs stored on an MP3 player, a list of still-images comprising various slide-shows, a list of movies stored in a DVD Jukebox, a list of TV shows currently being broadcast (e.g. an EPG), a list of songs stored in a CD Jukebox, a list of programs stored on a PVR (Personal Video Recorder) device, etc. Nearly any type of content can be listed via the CDS and multiple types of content (e.g. MP3, MPEG2, JPEG, etc) can be listed together by the CDS.

Content is stored in a hierarchical structure of UPnP container objects, each container having a collection of objects (media content) stored within them. Although the UPnP AV Working Committee has issued a set of class definitions (see Appendix C of the “Content Directory Service Template Version 1.01” for Universal Plug and Play Version 1.0, Jun. 25, 2002), UPnP does not require a Media Server's CDS to be arranged in a particular way and so the way in which containers and objects are arranged is decided by each vendor or user. Consequently, each CDS can have a unique structure and individual objects within the structure may be labelled with different combinations of descriptive metadata. Additionally, UPnP defines two mechanisms by which a CDS can be inspected by a querying device: a “Browse” mechanism by which a querying device can browse through the CDS structure and a more useful “Search” mechanism by which a querying device can request a CDS to return items meeting specified search terms. However, the “Search” mechanism is optional and it is possible that the CDS hosted by a Media Server does not implement UPnP's optional “Search” functionality but instead requires the CP to “Browse” it's hierarchy on a container-by-container basis.

Thus, a situation may arise where the storage structure exposed by the CDS is not a good fit to the content structure that the CP wishes to represent to the user, or the content retrieval methods it wishes to provide. Under these circumstances, the CP will find it laborious to extract the information that it's UI requires from the CDS structure. This has the disadvantage of extending the response time between a user making a query at a UI and the UI responding with an answer to the query. This degrades the user's experience of using the system.

U.S.2003/0046703 describes a system for facilitating access to content stored on a private network. Meta information about content stored on each of a number of network devices is aggregated by an aggregator module. The aggregated information can then categorized, either automatically or manually, for later querying. This system centrally holds full meta information for all content stored on the network.

The present invention seeks to provide an improved way of accessing a content directory service.

A first aspect of the present invention provides a method of providing media content information in a system comprising at least a querying device and a serving device which uses a content directory service (CDS) to store media content information, the method comprising the steps of:

retrieving selected media content information from the content directory service (CDS) of the serving device; and,

storing the retrieved media content information for future querying by the querying device.

Retrieving only selected information, such as information which is known to be of use to the querying device, rather than all of the information held by the CDS of a serving device, helps to minimise the size of the alternative, or ‘virtual’ CDS, making it easier to query, faster to respond and easier to maintain. This improves a user's experience of using the system. This also helps to minimise the amount of processing required by the querying device, which is a particular advantage when the querying device has limited processing resources, such as a portable device. Knowledge of what information is required by the querying device can be supplied in advance to the device which hosts the virtual CDS, or it can be derived by interrogating the querying device or devices.

Preferably, the retrieved information is reorganised into a form which is more compatible with the querying device. Preferably, the structure of the reorganised information is optimised for the specific browsing, searching and retrieval tasks of the user interface of a particular querying device. This further helps to reduce the amount of processing required to extract required information. Knowledge of the structure of the user interface of the querying device can be provided in advance, it can be derived by actively interrogating the querying device or it can be derived by analysing queries made by the querying device.

Preferably, the reorganisation of the retrieved information allows the information to be searched by the querying device. In UPnP systems, some storage devices only support a browse operation which can considerably extend the time required to retrieve information and the ability to search the information can greatly help to reduce response times.

Preferably, the steps of retrieving information and storing the reorganised information are performed on a periodic basis. This helps to ensure that the virtual CDS is as up-to-date as possible. The virtual CDS can be updated whenever an update occurs to the CDS of the storage device, any may be updated in response to receiving a notification from the digital storage device. Alternatively, the CDS can be polled on a periodic basis to check whether an update has occurred.

Preferably, the reorganised data or virtual CDS can be queried by multiple querying devices. The virtual CDS is provided as a service for devices in the network. This is particularly useful where some of the devices in the network have limited resources, such as a handheld, battery powered device with limited processing power. In this case, it is preferred that the virtual CDS service is hosted by a device with better resources, such as a mains powered personal computer (PC). Where a service is provided for multiple querying devices, the reorganised data can be stored in a plurality of different formats, each format being compatible with a different querying device.

Preferably, the information which is stored in the virtual CDS is retrieved from multiple serving devices, the virtual CDS aggregating the content into an easily accessible structure. This has the advantages of requiring a querying device to only access one device to retrieve content information rather than multiple devices, each having different response times and a CDS with a different structure. Thus, a more consistent access is provided to the content information.

The steps of retrieving information, reorganising the information and storing the information do not need to be performed by the same physical device. The retrieving and reorganising can be performed by a first device, with storage of the virtual CDS on a second device.

Another aspect of the invention provides apparatus for performing the method. The functionality described here can be implemented in software, hardware or a combination of these. Accordingly, a further aspect of the invention provides software for performing the method. The software may be stored on an electronic memory device, hard disk, optical disk or other machine-readable storage medium and will be executed by a suitable processing device on the host device. The software may be delivered as a computer program product on a machine-readable carrier or it may be downloaded directly to the host device via a network connection. It will be appreciated that the software may be installed at any point during the life of the host device.

The term ‘Content Directory Service’ (CDS) is intended to include the CDS used in UPnP systems, but it is not to be taken as limited to just UPnP systems. It can include any CDS-like storage system for media content information which has a hierarchical structure that is loosely defined and thus unpredictable and difficult for querying devices to extract required information from.

Embodiments of the present invention will now be described, by way of example only, with reference to the accompanying drawings, in which:—

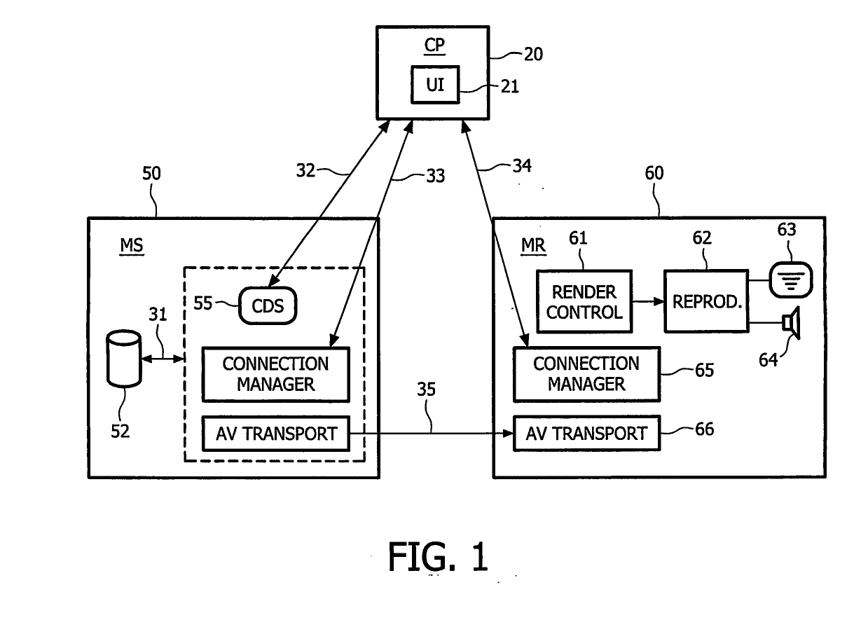

FIG. 1 shows the main components of a UPnP system;

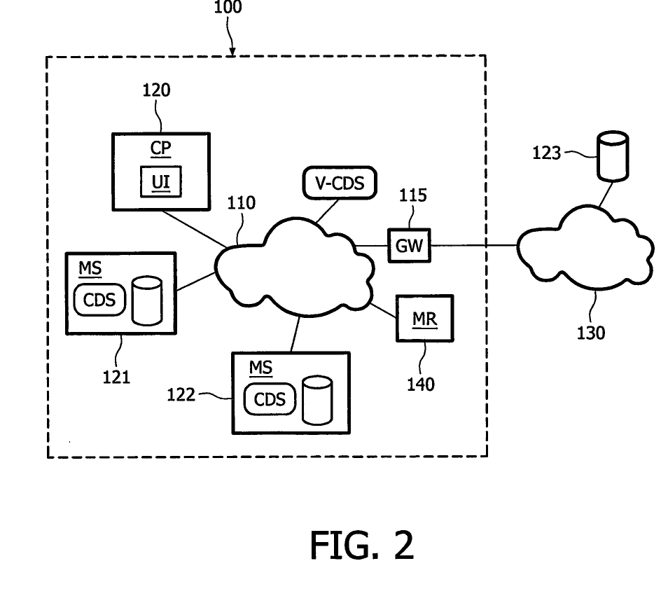

FIG. 2 shows a network of UPnP devices;

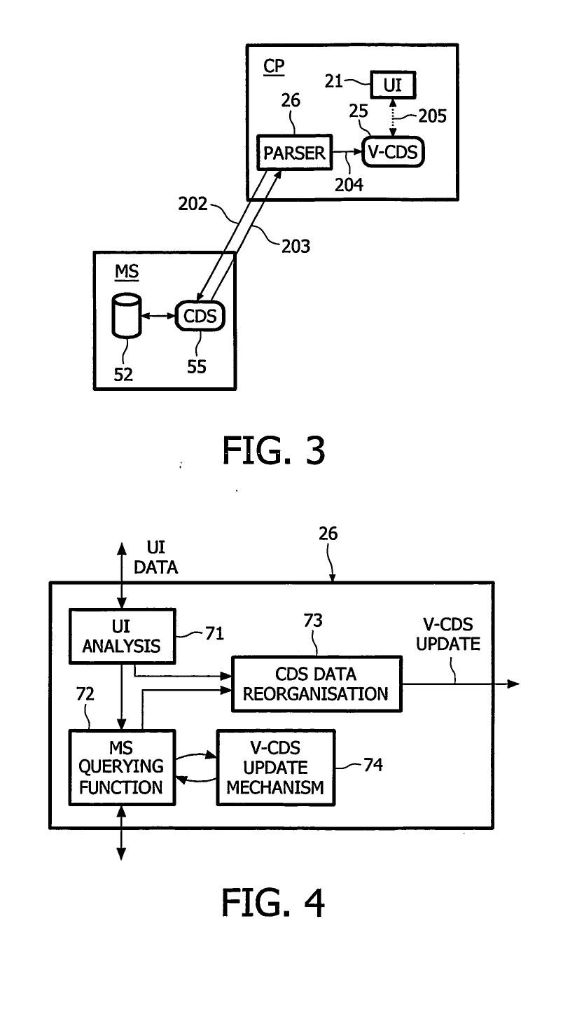

FIG. 3 shows a first embodiment of a virtual CDS in accordance with the invention;

FIG. 4 shows part of the arrangement of FIG. 3 in more detail;

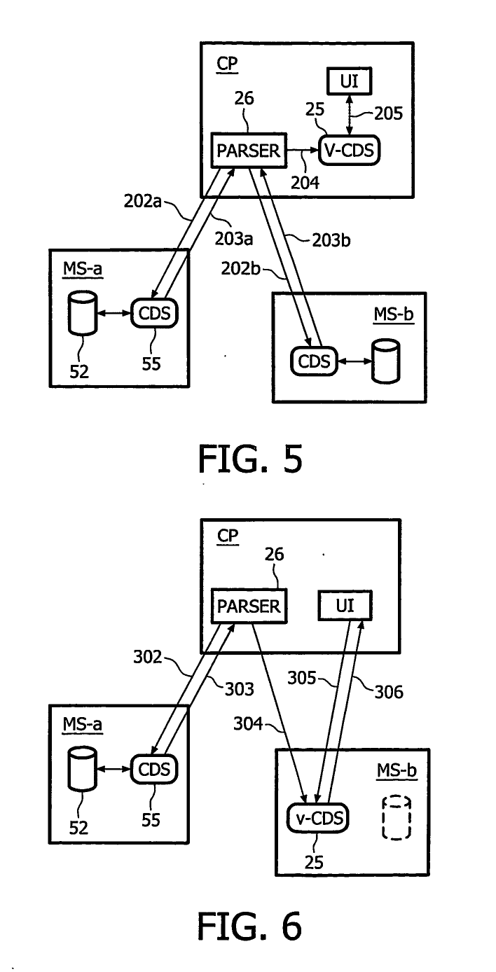

FIG. 5 shows a variant of the arrangement shown in FIG. 3 where the virtual CDS is created by querying multiple Media Servers;

FIG. 6 shows a further embodiment of the invention where the virtual CDS is hosted by an external Media Server;

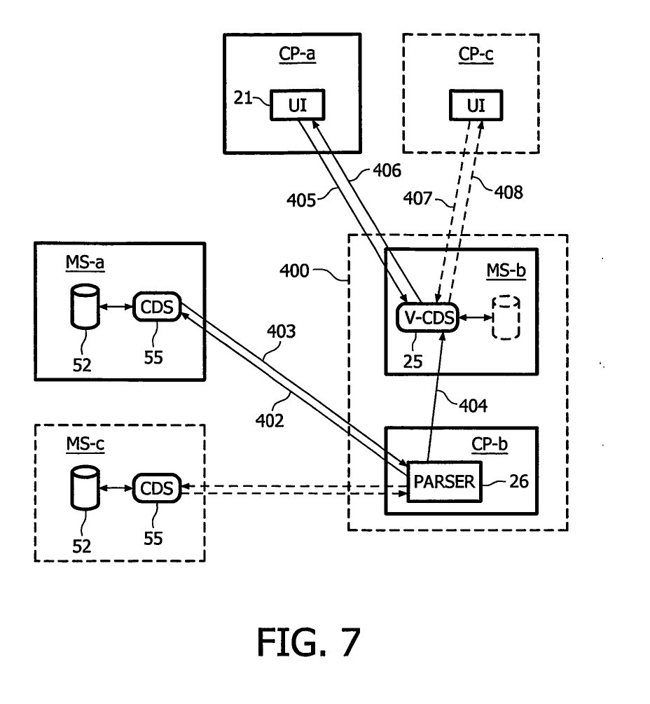

FIG. 7 shows a further embodiment of the invention where the creation and storage of the virtual CDS is hosted externally to the Control Point hosting the querying user interface;

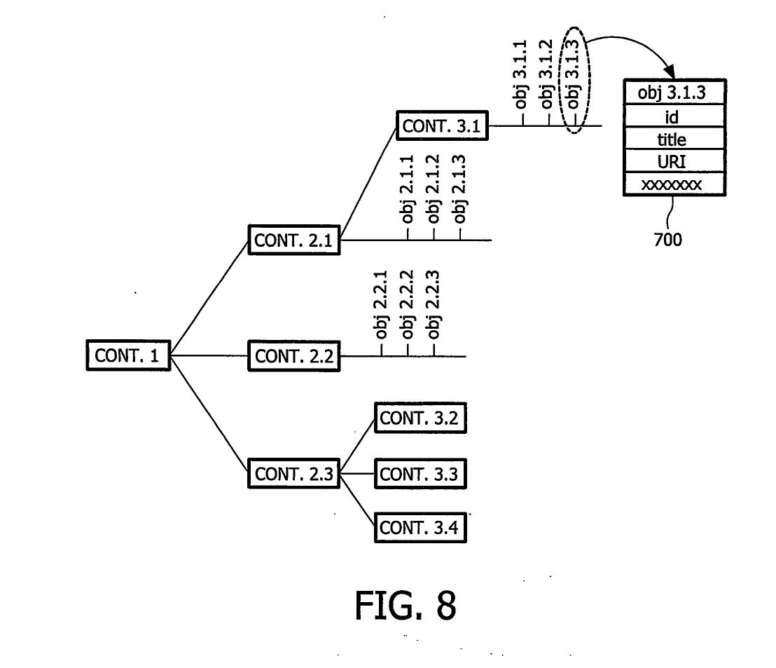

FIG. 8 shows an example structure of a CDS; and,

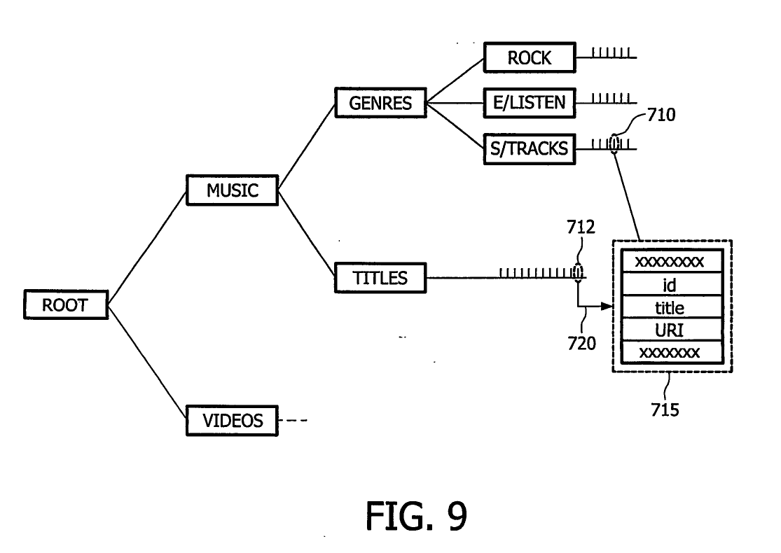

FIG. 9 shows an example structure of a virtual CDS.

Before describing the invention in detail, a conventional UPnP system will be briefly described. A more thorough explanation can be obtained from “UPnP AV Architecture” published by the UPnP Forum. The main components of a UPnP AV system are a Control Point (CP) 20, a Media Server (MS) 50 and a Media Renderer (MR) 60. All of these are logical entities: a physical device may include only one of these entities (e.g. a Control Point in the form of a remote control) or, more commonly, a combination of several of these entities. As an example, a CD player comprises a user interface and control circuitry for operating the player (a Control Point), apparatus for reading digital content from an optical disk (a Media Server) and apparatus for converting the digital content into an audio signal for presentation to a user (a Media Renderer).

Media Server (MS) 50 includes a store 52 of media content. The content can include audio, video, still images or a combination of these. The Media Server also supports a Content Directory Service (CDS) 55 which catalogues the content in store 52. The CDS is hierarchically organised in a manner similar to a computer file system. A container (analogous to a folder or directory) can include a plurality of objects (analogous to a file) and containers that are hierarchically one level lower. The object includes an object description with an identifier and optionally meta-data. The meta-data may include properties such as object name, artist, composer, date created, size, etc. The object may also include the object content (item) or include a locator, such as a URL, for locating the content. An example CDS structure is shown in FIG. 8. Further functions of the Media Server 50 are a Connection Manager Service which is used to manage connections between the Media Server 50 and other devices, such as the Media Renderer 60. An optional AV Transport Service allows control of the playback of content, with features such as stop, pause, seek etc.

Media Renderer (MR) 60 is responsible for rendering (reproducing) media content which is received from a Media Server 50. Reproduction equipment 62 is shown with a display 63 and speaker 64 although the output can take many forms. Typically, the reproduction equipment 62 includes one or more decoders, digital to analog converter and amplifiers. The Media Renderer 60 also supports a Connection Manager Service 65 for establishing a new connection with a Media Server and Render Control 61 for controlling the way in which the content is rendered. For audio reproduction this can include features such as a volume control.

Control Point (CP) 20 coordinates operation of the Media Server 50 and Media Renderer 60 and includes a user interface (UI) 21 by which a user can select content. The Control Point 20 supports the conventional UPnP mechanisms for discovering new devices and also supports mechanisms for finding the capabilities of Media Rendering devices and establishing connections between a Media Server and a Media Renderer. The UPnP AV Architecture supports a wide variety of AV devices such as TVs, VCRs, CD/DVD players/jukeboxes, set-top boxes, stereo systems, MP3 players, still-image cameras, camcorders, electronic picture frames (EPFs), and the PC. The AV Architecture allows devices to support different types of formats for the entertainment content (such as MPEG2, MPEG4, JPEG, MP3, Windows Media Architecture (WMA), bitmaps (BMP), NTSC, PAL, ATSC, etc.) and multiple types of transfer protocols (such as IEC-61883/IEEE-1394, HTTP GET, RTP, HTTP PUT/POST, TCP/IP, etc.).

Multiple physical devices, each having one or more or the CP, MS and MR entities, can be operated together as a network. FIG. 2 shows an example of a UPnP network which can represent a network of devices within a home. A Control Point 120, two Media Server devices 121, 122 and a Media Renderer device 140 are networked 110 together. The network 110 can be wired (e.g. Ethernet) or wireless (e.g. IEEE 802.11, Bluetooth). The media content can be wholly located on servers within the home network 100 or it can be located outside the home network 100. FIG. 2 shows a server 123 for storing content which is part of an external network 130, such as the Internet. This external server 123 is connected to the home network via a gateway 115.

Referring again to FIG. 1, this shows a conventional arrangement for accessing content over a UPnP network. The Media Server MS 50 maintains a Content Directory Service (CDS) 55 by interaction 31 with the local storage device 52. The Media Server 50 structures the CDS in a particular way, which may be dictated by the manufacturer of the MS. The CDS is updated as new content is added to the store 52. At some later time, a user interacts with user interface 21. Typically, the user interface 21 will present the user with a menu of possible options. As an example, an initial menu screen may ask the user whether they wish to retrieve an audio, video or image. In response to user selections at UI 22, the CP makes an appropriate query 32 of the CDS 55 of the MS 50. MS 50 responds with the required listing of content. When the user selects a piece of content, the CP instructs the MS and the MR to arrange an appropriate connection 33, 34 and to begin streaming the content 35 from the MS to the MR.

FIG. 3 shows a first embodiment of a system in accordance with the invention. In order to simplify the explanation, only the Control Point CP and Media Server MS are shown. The Control Point CP has been modified to include a virtual CDS v-CDS 25 and a parser function 26 which is responsible for maintaining the virtual CDS. As previously shown in FIG. 1, the Media Server MS maintains it's CDS 55 through interaction with it's local storage 52. When the CP and MS are first connected, parser 26 performs a series of queries on the CDS 202, 203 to create the virtual CDS 25. In the context of a UPnP system, in order for the virtual CDS to be accessible as a UPnP service, it needs to be a function of a MediaServer-type device, which can be embedded within a Control Point device.

The virtual CDS 25 is a data structure which contains only that data required by the CP, held in a structure optimized for responding to the queries generated by user interaction with the UI. When a user interacts with the user interface UI the virtual CDS, and not the actual CDS 55, is queried and a response is received 205. As previously, when the user selects an item of content, the CP instructs the MS and the MR to arrange an appropriate connection and to begin streaming the selected content from the MS to the MR.

Selected media content information is held in the virtual CDS for responding to queries. In the event that the CP requires additional information which is not stored in the virtual CDS, then the virtual CDS can retrieve this directly from the actual CDS of the MS (e.g. CDS 55 in FIG. 3) or the CP itself can retrieve the required information from the CDS of the MS. Additional information may be required to set up the connection to the Media Renderer device.

It should be noted that the process of the CP querying the Media Server MS occurs in advance of a user interacting with the user interface UI. In this way, when the user does come to interact with the user interface UI, the CP is able to provide a quick response. Also, because the virtual CDS is arranged in a manner which is compatible with the requirements of the user interface UI, the virtual CDS is better able to respond with the required data. Taking again the example of a user interface with an initial menu screen which asks the user whether they wish to retrieve an audio, video or image, the virtual CDS can be arranged to store media information in that format.

FIG. 4 shows the parser function 26 in more detail. In order to provide a virtual CDS which is better suited to the needs of a user interface, knowledge of the UI is needed. There are a variety of ways of obtaining knowledge of the UI:
it can be supplied as a data file which is stored on the host, either as part of the initial software or as a data file which is downloaded at a later date in the same manner as, for example, a printer driver;
it can be derived by active interrogation of the UI, such as by unit 71 which analyses the structure of a user interface;
it can be derived by dynamically, over a period of time, noting the queries that are received from the CP UI and adapting the structure of the virtual CDS to best match these types of query.
   In a further alternative, the virtual CDS can be provided with several default CDS views, with unit 71 selecting the best fit.

Knowledge of the UI falls into two categories:

(i) knowledge of what media content information the UI requires; and

(ii) knowledge of the structure (e.g. menu layout) of the UI.

Knowledge of what media content information the UI requires should be known at the time of creating the virtual CDS, as this dictates what content information the virtual CDS stores. If the virtual CDS stores too little, or the wrong, media content information then it cannot properly answer queries received from a CP. In contrast, knowledge of the structure of the UI is less important. The virtual CDS can reorganise media content information, during operation, into a more efficient structure as the virtual CDS acquires more knowledge of the querying requirements of the UI. In this manner, the virtual CDS adapts and becomes more efficient during operation.

Knowledge of what media content information the UI requires can take a number of forms. It can be a sub-set of objects e.g. music, video or photos. As an example, knowing that a UI only requires information on music content allows the parser function to retrieve only this information from a CDS for storage in the virtual CDS. The required information can be particular information about an object (possibly of a restricted sub-set of objects, as above), e.g. titles and genres, so the parser function does not retrieve, or at least does not store, information relating to release date, artist etc. The required information can be information at a particular level of granularity. As an example, a music browsing UI allows albums to be filtered according to their genre and/or artist name. Here, the parser only retrieves album title, genre and artist name for each album object, along with a reference to that album object in the original CDS. This very limited quantity of extracted information allows the v-CDS to support the query-intensive processes of searching, filtering, ordering and browsing at the album level of granularity. However, in order to examine a particular album in detail (e.g. retrieve a track listing), or to set up a connection to a play a particular track, further information is retrieved from the original CDS, using the album reference. The additional information can be retrieved by the virtual CDS or, more efficiently, by the CP which sent the query.

Knowledge of the UI is sent to units 72 and 73. An MS Querying function 72 formulates queries for submitting to a MS and receives replies. The queries 202 are formulated to extract information required by the UI. Extracted information is forwarded to a CDS data reorganisation unit 73 which reorganises the extracted data into a form which will be more useful to the UI. Unit 73 issues update messages which are forwarded to the virtual CDS for storage. The parser 26 continues to update the virtual CDS during the period that the CP and MS are connected to ensure that the virtual CDS is as accurate as possible. The MS may notify the CP whenever an update is made to the CDS. The notification may simply indicate that a change has been made somewhere in the CDS or it may more helpfully indicate in which container a change has been made. If a CDS does not indicate where a change has been made, the parser 26 may be arranged to begin creating a new virtual CDS. In the event that the MS does not notify the CP whenever an update is made, update mechanism 74 can be arranged to cause the parser to periodically poll the MS check whether an update has occurred to the CDS. Update mechanism 74 can use a timer set to a suitable value.

FIG. 5 shows a similar system to FIG. 3 but with two Media Server devices MS-a, MS-b. The creation of a virtual CDS has considerable benefits where there are multiple Media Server devices. Parser 26 operates in the same manner as described previously, querying 202a, 202b both of the Media Server devices and using the responses 203a, 203b to create a virtual CDS. The CDS of each Media Server device will almost certainly have a different structure. As before, parser 26 queries each MS to extract only the information it requires and reorganises that information into a structure which is compatible with the user interface UI. In effect, the virtual CDS aggregates information from the multiple MS devices and arranges this in a consistent format.

So far, the parsing function 26 and storage of the virtual CDS have been hosted by the Control Point which hosts the user interface. FIG. 6 shows an alternative implementation where the virtual CDS is constructed on a device which is remote from the CP which hosts the user interface. The parser 26 queries 302 the CDS of a Media Server MS-a and receives replies 303. After processing these replies 303 and extracting the required information, parser 26 sends a message to MS-b which hosts the virtual CDS to add the new information to the virtual CDS. The virtual CDS information may be appended to, or integrated with, the native CDS information of MS-b or it may be stored separately from the native information. In operation, user interface 21 of the CP queries the virtual CDS 305, 306. For UPnP, it is desirable that MS-b runs a distinct virtual CDS service in addition to (or instead of) it's native CDS, even if the ‘virtual’ metadata is appended to or integrated with, it's own native CDS. Making the virtual CDS distinct in some way is particularly important if it is intended to ‘replace’ several real CDSs. It is preferred that MS-b is a device which is better able to support the virtual CDS than the CP. It may, for example, have greater processing power or storage resources, with improved ability to query metadata.

FIG. 7 shows a further alternative implementation in which all of the functionality of creating and storing the virtual CDS is hosted externally to the CP which hosts the user interface. The user interface is hosted by a first Control Point, CP-a. A parser function 26 is hosted by a second Control Point CP-b while a virtual CDS 25 is hosted by a Media Server MS-b. CP-b and MS-b may be realised as a single physical device, as shown by dashed box 400. Alternatively, the UPnP Control Point CP-b could actually be embedded within the UPnP MediaServer MS-b.

Parser 26 is responsible for querying 402, 403 the CDS of Media Server MS-a, extracting the required information and reorganising this into a form for storage by the virtual CDS 25. CP-a queries 405 the virtual CDS 25 in response to user interaction with the user interface 21. Virtual CDS provides an appropriate response 406.

Device 400 may be dedicated to providing this service or it may provide this service in addition to performing other duties. The service could be provided as one of the functions of a home hub device, the main purpose of which is to route AV content between different entertainment devices. Also, it could simply be software running on a PC.

As shown, the parser 26 can query multiple Media Sever devices MS-a, MS-c and aggregate the retrieved information in the manner previously described. Also, virtual CDS 25 can respond to queries from multiple Control Points, CP-a, CP-c, each having their own user interface UI. It is likely that the UI of each CP will have a different structure, and thus will require different information from the CDS of a MS. As explained below, the virtual CDS can arrange information in multiple ways, each being compatible with the requirements of the UI of a client CP. CP-b, MS-b provide a service on behalf of devices on the network. CP-b, MS-b can be arranged to automatically perform the duty of providing the virtual CDS service or they can be arranged to perform this duty at the specific request of a CP hosting a UI, such as CP-a. The delegation of management of the virtual CDS to a remote device will reduce the workload of the CP hosting the UI, providing an improvement in responsiveness.

FIG. 8 shows an example structure of a Content Directory Service (CDS) of a MS. The CDS has a hierarchical structure of containers and objects. Containers hold multiple objects, e.g. a music album is a container holding multiple audio items. As illustrated, containers can hold further sets of containers (as with container 2.3 holding containers 3.2, 3.3, 3.4) or multiple items. Each object is defined by a number of properties. One such object, Object 3.1.3, is shown in more detail. In UPnP the properties must include an identifier such as an ‘id’ and ‘title’ (name). The object can include a Uniform Resource Identifier (URI) which points to the location of the media object. The object may be stored in the storage device within the Media Server (e.g. store 52 in FIG. 1) or in a server externally of the Media Server. A property of a container is a field which indicates whether the container can be searched. Further properties, including meta-data 700, can also be included in the information.

An example scenario will now be described with reference to FIG. 9. A system has two CP devices and several MS devices. A virtual CDS is created which will be used by the two Control Points and which will store selected information from the CDSs of the MS devices. Each of the MS devices has a large capacity and consequently their CDSs store media content information for a wide range of content: music, videos, photos, electronic books, etc. The first CP has a user interface which initially asks the user to choose between “Music” or “Videos”. In response to choosing “Music” the user interface presents the user with choices of different musical genres: “Rock”, “Easy Listening” and “Soundtracks”. In response to choosing any of these, the user interface presents the user with a list of available audio items or the option to search for an item of interest. The second CP has a user interface which only deals with audio items. The user interface asks the user to select a title of an audio track, or to search for a title for an audio track.

FIG. 9 shows the structure of the virtual CDS that is created. Firstly, the virtual CDS notes that the CP devices only require information about media which is either audio or video. Thus, the virtual CDS does not need to retrieve information about photos or e-books. In order to work efficiently with the first UI, the virtual CDS is arranged in a similar way to the menu structure of the first UI. A first level of containers are labelled “Music” and “Videos”. The container for “Music” holds a further container labelled “Genres”, which in turn holds containers for “Rock”, “Easy Listening”, “Soundtracks”. Each of these containers includes a list of objects, each referencing an audio item. In addition, searching is enabled on the containers for each genre, thereby allowing the UI to quickly retrieve the information for any desired object without the need to search through the entire contents of a container. In order to create the virtual CDS, the parser function queries each MS device it is in contact with to retrieve the required information. Some of the MS devices that the parser queries may simply have a CDS with one large container for audio items, making no distinction between genres, although the genre information is included in the property field of each entry in the CDS. It is also possible that there is no genre information at all and the virtual CDS may need to make a best guess for genre or place in “undefined” genre. The parser makes a series of queries to retrieve the information. Some of the MS devices are unlikely to support searching and so the parser will need to make multiple queries to retrieve the required information.

In order to work efficiently with the second UI, the virtual CDS includes a container labelled “Titles” which includes a list of objects, each referencing an audio item. In addition, searching is enabled on the container, thereby allowing the UI to quickly retrieve the information for any desired object without the need to search through the entire contents of the container.

In this example, the same objects can effectively appear multiple times in the virtual CDS. Object 710 in the soundtracks container is equivalent to item 710 in the Titles container. Object 712 has a pointer 720 which points to property information 715 associated with object 710. This avoids the need to store duplicate lists of property information in the virtual CDS.

1. A method of providing media content information in a system comprising at least a querying device (CP) and a serving device (MS) which uses a content directory service (CDS) to store media content information, the method comprising the steps of:
retrieving selected media content information from the content directory service (CDS) of the serving device (MS); and,
storing the retrieved media content information (V-CDS) for future querying by the querying device.

2. A method according to claim 1 wherein the step of retrieving selected media content information uses knowledge of what media content information the querying device requires.

3. A method according to claim 2 further comprising obtaining knowledge of what media content information the querying device requires.

4. A method according to claim 3 further comprising interrogating the querying device to determine the knowledge of what media content information the querying device requires.

5. A method according to claim 1 further comprising reorganising the retrieved media content information into a form which is more compatible with the querying requirements of the querying device.

6. A method according to claim 5 wherein the step of reorganising the media content information comprises reorganising the media content information in a manner which is more compatible with the user interface of the querying device.

7. A method according to claim 5 wherein the step of reorganising the media content information uses knowledge of the querying device.

8. A method according to claim 7 further comprising obtaining knowledge of the querying device.

9. A method according to claim 8 wherein knowledge of the querying device is obtained by interrogating the querying device.

10. A method according to claim 8 wherein knowledge of the querying device is obtained by analysing queries made by the querying device.

11. A method according to claim 5 wherein the step of reorganising the media content information comprises reorganising the media content information so that it can be searched by the querying device.

12. A method according to claim 5 wherein the reorganised data is stored in a plurality of different formats, each format being compatible with a different querying device.

13. A method according to claim 1 wherein the steps of retrieving media content information and storing the retrieved media content information are performed on a periodic basis.

14. A method according to claim 13 further comprising the step of receiving an indication from a serving device when an update occurs to that device's CDS and updating the reorganised media content information in response to receiving the indication.

15. A method according to claim 5 wherein the steps of retrieving and reorganising the media content information are performed by a first device and the step of storing the reorganised media content information is performed on a second device.

16. A method according to claim 1 which is performed for a plurality of querying devices, wherein the step of retrieving selected media content information retrieves media content information required by the plurality of devices.

17. A method according to claim 1 wherein the step of retrieving information retrieves media content information from the CDS of a plurality of serving devices.

18. A method according to claim 16 wherein the step of reorganising the media content information reorganises the media content information from the plurality of serving devices according to a common set of criteria.

19. A method according to claim 1 further comprising:
receiving a query for media content information from the querying device;
determining whether the stored media content information is sufficient to answer the query and, in the event that the stored media content information is not sufficient, causing the required media content information to be retrieved from the CDS of the serving device.

20. Software for causing a processor to perform the method according to claim 1.

21. Apparatus for performing the method according to claim 1.

22. Apparatus for providing media content information in a system comprising at least a querying device (CP) and a serving device (MS) which uses a content directory service (CDS) to store media content information, the apparatus comprising:
means for retrieving (26) selected media content information from the content directory service (CDS) of the serving device (MS); and,
means for storing (V-CDS) the retrieved media content information for future querying by the querying device (CP).

23. Apparatus according to claim 22 wherein the retrieving means (26) uses knowledge of what media content information the querying device (CP) requires.

24. Apparatus according to claim 23 further comprising means for obtaining knowledge of what media content information the querying device (CP) requires.

25. Apparatus according to claim 24 wherein the means for obtaining knowledge is arranged to interrogate the querying device to determine the knowledge of what media content information the querying device requires.

26. Apparatus according to claim 22 further comprising means for reorganising the retrieved media content information into a form which is more compatible with the querying requirements of the querying device.

27. Apparatus according to claim 26 wherein the reorganising means is arranged to reorganise the media content information in a manner which is more compatible with the user interface of the querying device.

28. Apparatus according to claim 26 wherein the reorganising means uses knowledge of the querying device.

29. Apparatus according to claim 28 further comprising means for obtaining knowledge of the querying device.

30. Apparatus according to claim 29 wherein the means for obtaining knowledge of the querying device is arranged to interrogate the querying device.

31. Apparatus according to claim 29 wherein the means for obtaining knowledge is arranged to analyse queries made by the querying device.

32. Apparatus according to claim 26 wherein the reorganising means is arranged to reorganise the media content information so that it can be searched by the querying device.

33. Apparatus according to claim 26 wherein the reorganised data is stored in a plurality of different formats, each format being compatible with a different querying device.

34. Apparatus according to claim 26 wherein the retrieving means and reorganising means are located on a first device and the storing means are located on a second device.

35. Apparatus according to claim 22 which provides a service for a plurality of querying devices, wherein the retrieving means retrieves selected media content information required by the plurality of devices.

36. Apparatus according to claim 35 which is physically separate from the querying devices.

37. Apparatus according to claim 22 wherein the retrieving means is arranged to retrieve media content information from the CDS of a plurality of serving devices.

38. Apparatus according to claim 22 further comprising:
means for receiving a query for media content information from the querying device;
means for determining whether the stored media content information is sufficient to answer the query and, in the event that the stored media content information is not sufficient, causing the required media content information to be retrieved from the CDS of the serving device.

39. A method, software or apparatus according to claim 1 wherein the system is a Universal Plug and Play (UPnP) system.
